(19) United States
(12) Patent Application Publication
(10) Pub. No.: US 2009/0161638 A1
(43) Pub. Date: Jun. 25, 2009

(54) TELECOMMUNICATIONS NETWORK

(75) Inventor: Sean Mullen, Northumberland (GB)

Correspondence Address: Weaver Austin Villeneuve & Sampson LLP, P.O. BOX 70250, OAKLAND, CA, 94612-0250, US

(73) Assignee: UBIQUISYS LIMITED, Wiltshire (GB)

(21) Appl. No.: 12/277,156

(22) Filed: Nov. 24, 2008

(30) Foreign Application Priority Data
Nov. 23, 2007 (GB) 0723099.8

(51) Int. Cl. H04J 3/00

(52) U.S. Cl. 370/336

(57) ABSTRACT

A basestation of a telecommunications network is able to acquire timing information by sending a single time request message over a computer network to a time server, with the time request message specifying a number of time response messages, said number being greater than one. Based on the received specified number of time response messages from the time server, the basestation is able to calibrate an internal oscillator.

### CROSS-REFERENCE TO RELATED APPLICATION

This application claims priority from U.K. Patent Application No. 0723099.8, filed on Nov. 23, 2007, which is hereby incorporated by reference.

This invention relates to a method of calibrating an oscillator, and in particular to a method of calibrating an oscillator using data from a network time server, and to an oscillator control system using such a method.

In another aspect, the invention relates to a network time server, which can be used to provide timing signals suitable for such calibration.

A basestation, for use in a mobile communications network, must often be able to generate signals having frequencies that are highly accurate. For example, using a signal generated by an oscillator within the basestation, the basestation must be able to transmit a signal with a frequency that is within a very tightly specified frequency band. This puts very stringent requirements on the accuracy of the oscillator itself.

However, conventional oscillators having the required accuracy are somewhat expensive. In the case of a basestation, such as a femtocell basestation, that is only intended to provide service for a relatively small number of users, this expense is hard to justify.

It has therefore been proposed that the femtocell basestation should include a relatively low cost, and thus inherently somewhat inaccurate oscillator, but should include a mechanism for monitoring and maintaining the required frequency accuracy of the oscillator. Since each femtocell basestation has a computer network connection, such as an internet connection allowing traffic to be passed to and from the core network of the mobile network operator, the femtocell basestation can receive time information from a time server.

By measuring the time difference between the arrival times of multiple time packets, as measured by a clock derived from the oscillator, and comparing this time difference with the time difference as measured at the time server, the oscillator control system can monitor the frequency accuracy of the oscillator.

However, conventional time server protocols operate on a request/response basis. That is, a time server must receive a request from a computer on the network before sending a response. Extrapolating this scenario to the case where thousands of femtocell basestations are all requesting responses from a time server shows that a significant amount of bandwidth will be required on the uplink between the basestations and the internet.

### SUMMARY OF INVENTION

According to a first aspect of the present invention, there is provided a method of acquiring time references in a basestation of a telecommunications network, the basestation being further connected to a computer network comprising one or more time servers, the method comprising:

sending a time request message to a time server, said time request message specifying a number of time response messages, said number being greater than one; and

receiving said specified number of time response messages from the time server at the basestation.

According to a second aspect of the present invention, there is provided a basestation, for use in a telecommunications network, the basestation being adapted to send a time request message to a time server, said time request message specifying a number of time response messages, said number being greater than one; and being further adapted to receive said specified number of time response messages from the time server at the basestation.

According to a third aspect of the present invention, there is provided a time server, for use in a telecommunications network, the time server being adapted to receive a single time request message specifying a number of time response messages, said number being greater than one; and being adapted to send said specified number of time response messages.

This allows for the calibration of an oscillator while limiting the amount of bandwidth that is required on the uplink between the basestations and the internet.

### BRIEF DESCRIPTION OF THE DRAWINGS

For a better understanding of the present invention, and to show more clearly how it may be carried into effect, reference will now be made, by way of example, to the following drawings, in which:

FIG. 1 is a block schematic diagram of a part of a communications network operating in accordance with the present invention.

### DETAILED DESCRIPTION

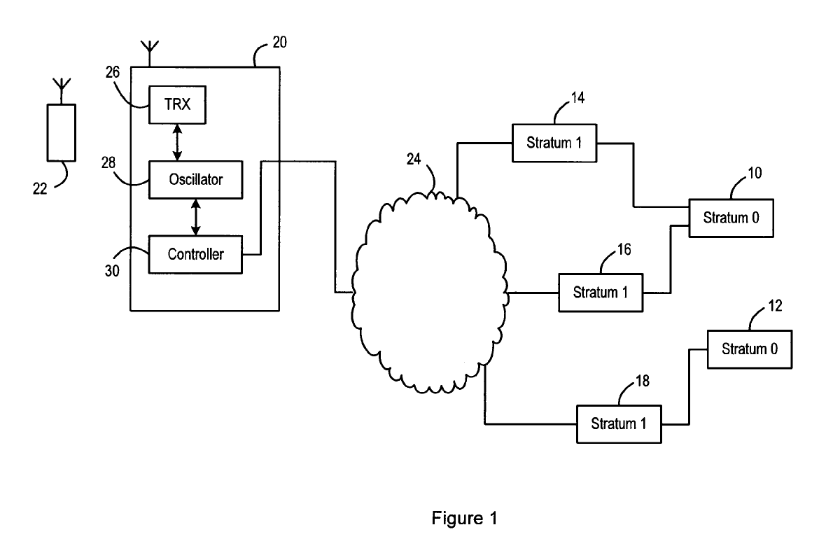

As is known, there exist time server computers, which can be accessed over computer networks to provide network-connected devices with accurate time information using, for example, the Network Time Protocol. As shown in FIG. 1, there are Stratum 0 devices 10, 12, which are typically extremely accurate clocks. Connected to the Stratum 0 devices 10, 12 are Stratum 1 devices 14, 16, 18, which are inevitably slightly less accurate than the Stratum 0 devices, but which are sufficiently accurate to be used as time servers by a wide range of other devices.

In this case, there is shown a femtocell basestation 20, which is able to establish a connection over a specified wireless interface with one or more mobile devices 22 located within its radio coverage area. The femtocell basestation 20 has a connection to the internet 24, which it uses for receiving traffic from the core network of the mobile network operator of whose network it forms a part. It is of course then also able to use the internet connection to establish a connection to one or more of the time servers 14, 16, 18.

The femtocell basestation 20 includes radio transceiver circuitry (TRX) 26, which has to be able to transmit and receive signals on specified frequencies with a high degree of accuracy, in order to comply with the relevant standards. The transmit and receive frequencies are generated from signals generated by an oscillator 28. In order to reduce the cost of the femtocell basestation 20, it is advantageous to be able to use an oscillator 28 that is inherently unable to generate signals with the required frequency accuracy. The oscillator 28 may therefore be a voltage controlled oscillator, which generates signals at frequencies that can be adjusted by control voltages applied thereto, and is controlled by a controller 30 that can connect over the internet 24 to one or more of the time servers 14, 16, 18.

In order to be able to control the oscillator 28, and thus ensure the required frequency accuracy, a control process is performed in the controller 30, as described below.

Periodically, the controller 30 may determine that it is necessary to check the frequency accuracy of the oscillator 28. This check may be performed at regular intervals, or when a specified event indicates that a check is required, or when some measured parameter (for example such as an ambient temperature) suggests that a check may be required. One method is to take measurements from signals received from other basestations in the mobile network, calculate the frequency error of the receive frequency and correct the local oscillator accordingly.

An alternative method may be used, for example when it is not possible to detect signals from any other basestations. Thus, it is determined that it is necessary to check the frequency accuracy of the local oscillator 28 using Network Time Servers (NTS) operating in accordance with the Network Time Protocol. Responses from the time servers allow the controller 30 to acquire accurate time references, and from these time references calculate the frequency of the local oscillator, and adjust it if required. There are several protocols for acquiring a time reference from an NTS. In the embodiment described here, NTPv4 is used, but the invention is not limited to use of this protocol.

The method relies on reading a timestamp applied to an NTS response message, and comparing it with a timestamp applied in the femtocell basestation 20 to obtain a value for a network delay. One method for calibrating the oscillator could simply rely on taking a large number of measurements, and using an averaging process to obtain a value for the network delay. An assumption could then be made that any apparent changes in this network delay over time will in fact have been caused by inaccuracies in the clock in the femtocell basestation 20 (caused in turn by frequency inaccuracy in the oscillator 28).

Another method relies on the assumption that there is a certain minimum network delay, which will remain essentially constant over time, and hence that apparent changes in this minimum network delay over time will be caused by inaccuracies in the clock in the femtocell basestation 20 (caused in turn by frequency inaccuracy in the oscillator 28). However, each individual response message from the NTS to the femtocell basestation 20 will be subject not only to this minimum network delay, but possibly also to an additional delay, referred to as jitter.

This alternative method therefore attempts to select response messages that have been subject only to minimum network delay, in order to be able to detect any apparent changes in this minimum network delay over time. The frequency inaccuracy that might have caused such apparent changes can then be corrected.

In order for the controller 30 to accurately determine the minimum network delay, then, a great number of NTS response messages are required. In fact, one method requires “bursts” of NTP response messages to be sent from the time server to the basestation. From each burst, the message with the minimum network delay is selected. Further, the results from each burst are collated and analysed to determine a reliable figure for the minimum network delay over a period of time.

However, as previously mentioned, such time server protocols rely on communication of a request/response nature, generating unwanted traffic on the uplink.

Therefore, according to the present invention, the NTSs 14, 16, 18 are adapted to receive ‘special’ requests, and to send out bursts of NTS response messages at intervals in response to receiving just one ‘special’ request.

Each burst contains a plurality of NTS response messages with, in one embodiment, the number of NTS response messages per burst being configurable within a field in the special request.

Within each burst, each NTS response message is separated from the next NTS response message by an internal time interval with, in one embodiment, the internal time interval being configurable within a field in the special request.

Further, each burst is separated from the next burst by an external time interval with, in a further embodiment, the external time interval being configurable within a field in the special request.

Thus, according to the present invention, just one special request is required in order for the NTS to send a plurality of NTS response messages to the basestation 20.

The internal time interval between NTP response messages within a burst may, for example, be approximately 10 ms. The external time interval between bursts may, for example, be approximately 15 seconds.

According to one embodiment, the basestation 20 may send the special request to the time server 14, 16, 18. That is, as aforementioned, the controller 30 in the basestation 20 may determine that it is necessary to check the accuracy of the oscillator 28 and therefore send a special request to the time server 14, 16, 18.

According to an alternative embodiment, a management system (not shown) associated with the network may send the special request to the time server 14, 16, 18.

If the management system sends the special request to the time server 14, 16, 18, it may arrange the timings of the NTP messages such that the majority of the messages are sent at times of the day when the load on the network is at its lowest, e.g. at night.

Thus, the invention has provided a protocol for maintaining the accuracy of an oscillator within a basestation, such that the amount of traffic on the uplink between the basestation and the network is minimized. In order to reduce the traffic on the uplink still further, and to maintain support for legacy systems whilst still taking advantage of the present invention, the special request may take the form of a standard request message that has been adapted.

For example, the reference clock ID field of the standard NTP request datagram may be used to specify the number of synchronization messages per burst, the internal time interval, the external time interval, or any combination of these quantities. This field is normally cleared by the requester and is used by the time server, when responding, to describe the nature of its clock reference (e.g. GPS, atomic clock, etc). However, in order to achieve the ‘legacy’ benefits mentioned above, any standard message may in principle be used as a ‘special’ request. All that it required is a field which is not normally used when sending messages to the time server.

Further, although one possibility is that the reference clock ID field of the standard NTP request datagram may be used to specify the number of synchronization messages per burst, the internal time interval, the external time interval, or any combination of these quantities, another possibility is that an entirely new IP/UDP packet could be defined to contain the specified information.

The present invention is envisaged to work in parallel to the ordinary operation of the time servers. That is, the time servers should still be able to receive and respond to individual normal NTP requests.

Further, although the majority of the above description has been in reference to NTP, it will be apparent to those skilled in the art that the invention applies equally to any time-server-based protocol.

Similarly, although the invention has been described primarily with reference to the acquisition of time references in a basestation of a telecommunications network, it will be apparent that the same request message may be sent from any network computer having a requirement for accurate time information.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A method of acquiring time references in a basestation of a telecommunications network, the basestation being further connected to a computer network comprising one or more time servers, the method comprising:
sending a time request message to a time server, said time request message specifying a number of time response messages, said number being greater than one; and
receiving said specified number of time response messages from the time server at the basestation.

2. A method as claimed in claim 1, wherein said time request message is sent from said basestation.

3. A method as claimed in claim 1, wherein said telecommunications network further comprises a management system, and wherein said time request message is sent from said management system.

4. A method as claimed in claim 1, wherein said number of time response messages is transmitted with a first time interval between consecutive time response messages of said number of time response messages.

5. A method as claimed in claim 4, wherein said time request message further specifies the length of the first time interval.

6. A method as claimed in claim 1, further comprising:
transmitting again said number of time response messages from the time server to the basestation, the time between the first transmission and the second transmission defining a second time interval.

7. A method as claimed in claim 6, wherein said time request message further specifies the length of said second time interval.

8. A method as claimed in claim 1, wherein said time request message is an adaptation of a standard message.

9. A method as claimed in claim 8, wherein the standard message is a NTP request datagram.

10. A method as claimed in claim 1, wherein said time request message is an adaptation of a NTP request datagram, and wherein said number of time response messages is specified in the Reference Clock ID field of the NTP request datagram.

11. A method as claimed in claim 5, wherein said time request message is an adaptation of a NTP request datagram, and wherein said first time interval is specified in the Reference Clock ID field of the NTP request datagram.

12. A method as claimed in claim 7, wherein said time request message is an adaptation of a NTP request datagram, and wherein said second time interval is specified in the Reference Clock ID field of the NTP request datagram.

13. A method as claimed in claim 1, the method further comprising:
within the basestation, using said time response messages to calibrate an internal oscillator.

14. A basestation, for use in a telecommunications network, the basestation being adapted to send a time request message to a time server, said time request message specifying a number of time response messages, said number being greater than one; and being further adapted to receive said specified number of time response messages from the time server at the basestation.

15. A basestation as claimed in claim 14, being further adapted to calibrate an internal oscillator based on the received time response messages.

16. A time server, for use in a telecommunications network, the time server being adapted to receive a single time request message specifying a number of time response messages, said number being greater than one; and being adapted to send said specified number of time response messages.

17. A time server as claimed in claim 16, wherein said time response messages are transmitted with a first time interval between consecutive time response messages of said number of time response messages.

18. A time server as claimed in claim 17, wherein said time request message further specifies the length of the first time interval.

19. A time server as claimed in claim 16, being further adapted to transmit again said specified number of time response messages after a second time interval.

20. A time server as claimed in claim 19, wherein said time request message further specifies the length of the second time interval.

21. A time server as claimed in claim 16, wherein said time request message is an adaptation of a standard message.

22. A time server as claimed in claim 21, wherein the standard message is a NTP request datagram.
